(19) United States
(12) Patent Application Publication
(10) Pub. No.: US 2012/0193470 A1
(43) Pub. Date: Aug. 2, 2012

(54) Wide-body supersonic airliner

(76) Inventor: Patrick A. Kosheleff, Yankee Hill, CA (US)

(21) Appl. No.: 12/931,409

(22) Filed: Feb. 1, 2011

(51) Int. Cl. B64C 25/12; B64C 30/00; B64D 11/00

(52) U.S. Cl. 244/102 R

(57) ABSTRACT

An airliner in which the wheel bogies of the main landing gear are stored one behind the other in a narrow, hollow keel at the bottom of the fuselage. The narrow keel replaces the usual voluminous hold under the passenger cabin. This decreases the cross-sectional area of the fuselage, to reduce aerodynamic drag.

One main strut of the landing gear angles forward during retraction, while the other strut angles backward. That allows the bogie tandem storage. It also requires swiveling a bogie as it enters the keel. The folding of the drag brace during strut retraction powers the swiveling mechanism. Elsewhere, the side brace folds and twists during retraction.

Dividing the main wing spar at the fuselage and passing only the bottom half under the cabin preserves the reduced hold volume. The decreased cross-sectional area allows the passenger cabin to be enlarged. It creates a “wide-body” supersonic airliner able to carry more passengers.

### BACKGROUND OF THE INVENTION

An airliner design is disclosed which includes a greatly reduced hold volume under the passenger cabin. The bulky wing spar divides into thinner halves where it reaches the fuselage, passing over and under the passenger cabin, for a thin profile.

Similar structure already exists. In the B-1 bomber, which lacks a passenger cabin, the flanges of the wing spar follow the contours of the fuselage, and the spar's web is a tall, thin bulkhead joining the flanges. See FIG. 5 of Paper 730348, Transactions of the Society of Automotive Engineers, 1973, page 1138. The goal there was weight savings.

A variant of that is “How Different a Modern SST Would Be”, Aerospace America, November 1986, page 26. It proposes to divide the spar at the fuselage. The upper half of the spar is routed through the roof structure of the cabin. The lower half is part of the cabin floor. Wing loads are carried that way. A shallower fuselage is obtained.

The reduction in the cross sectional area of our fuselage suggests widening it to carry more passengers. The usual voluminous hold under the passenger cabin is eliminated. A hollow keel is kept, just wide enough to store the wheel bogies of the main landing gear. The bogies are stored in tandem. This keeps the cross-sectional area of the keel at a minimum. No prior example of tandem bogie storage was found.

To make tandem bogie storage possible, one landing gear strut retracts with a forward angle, and the other strut retracts with a backward angle. Retraction with an angle is seen in U.S. Pat. No. 5,000,400. Bogies must also swivel to enter the keel cleanly. Swiveling during retraction is found in U.S. Pat. No. 4,984,755 and many others. Our side brace twists while folding. In U.S. Pat. No. 3,086,733, the drag brace twists while folding.

### SUMMARY OF THE INVENTION

The first object of the invention is to significantly reduce the cross-sectional area of an airliner. The hold volume below the passenger cabin is greatly decreased. That is where the large wing spar normally passed through. The method begins by dividing the wing spar and re-routing the thinner branches over and under the passenger cabin. The method is already known in the art. We may add partial bulkheads to brace the fuselage's corners. The main problem is where to store the bulky wheel bogies of the landing gear now that the voluminous hold is gone. A substitute is found.

Another goal is to make the changes useful to a civilian super-sonic airliner. In such an aircraft, the wings are usually too thin to house the wheels of the landing gear. The solution is to retract the wheel bogies of the landing gear into a narrow, keel-like volume just under the passenger cabin. The narrowness is for reduced cross-sectional area. This decreases drag. It's the smallest replacement possible for the hold volume obviated by the use of a divided spar. Thus, retracting the landing gear involves placing the wheel bogies one behind the other in the narrow keel. During retraction, one strut angles sharply forward, and the other strut angles sharply backward. Therefore, the axis of retraction for a strut is skewed relative to the fuselage. But during landing, the bogie pointed straight ahead; it was “toed-in” relative to the re-traction axis. A mechanism is added to swivel the wheel bogie back to parallel to the retraction axis. Then the bogie avoids bottoming one wheel too soon in the keel at the end of the strut's retraction.

The narrow keel preserves the large reduction in the cross-sectional area of the fuselage. That decreases the supersonic wave drag. Thus, the passenger cabin can be widened to carry more passengers. The overall intent is to achieve a “wide-body” supersonic transport aircraft design with performance approaching that of existing narrow-body Mach 2 airliners. Calculations will be presented at the end to support this view.

### BRIEF DESCRIPTION OF THE VIEWS

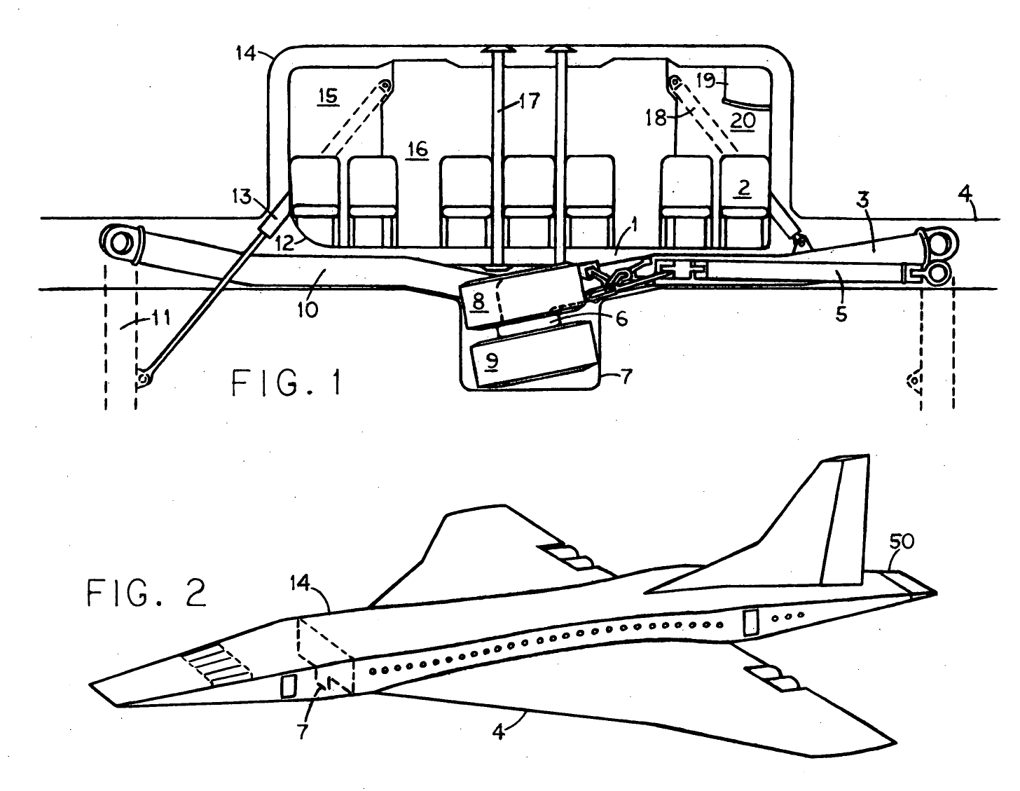

FIG. 1 is a transverse elevation of the cabin of a wide-body airliner.

FIG. 2 is an oblique elevation side view of a supersonic airliner.

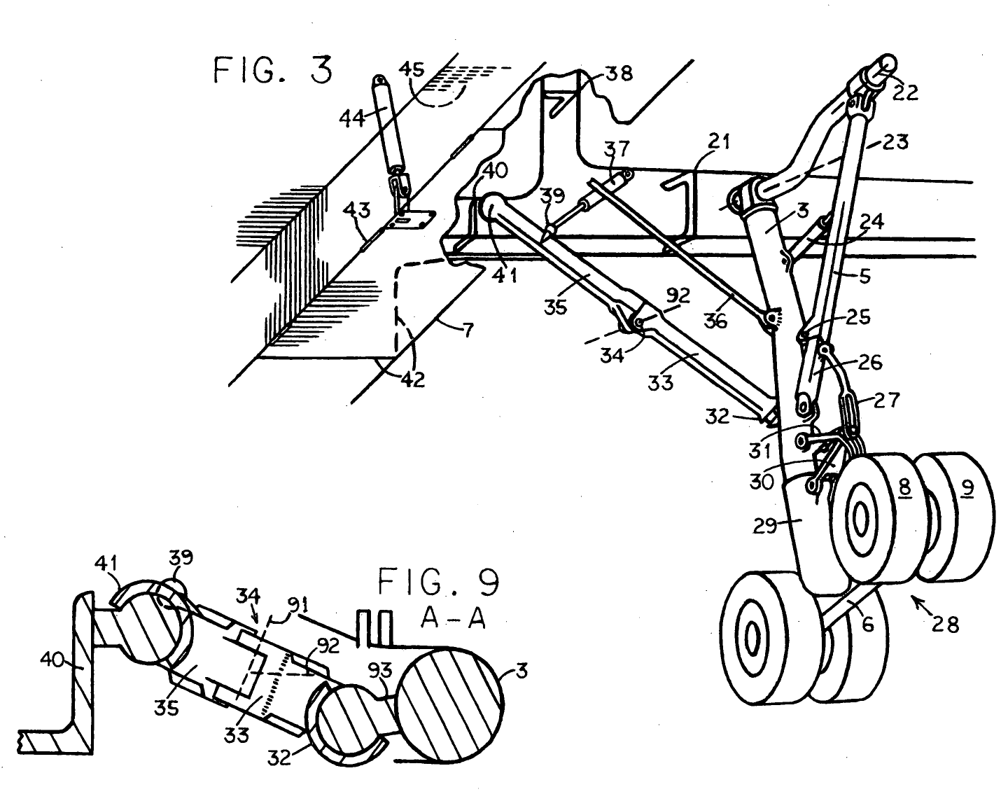

FIG. 3 is a ¾ underside view of an extended main landing gear.

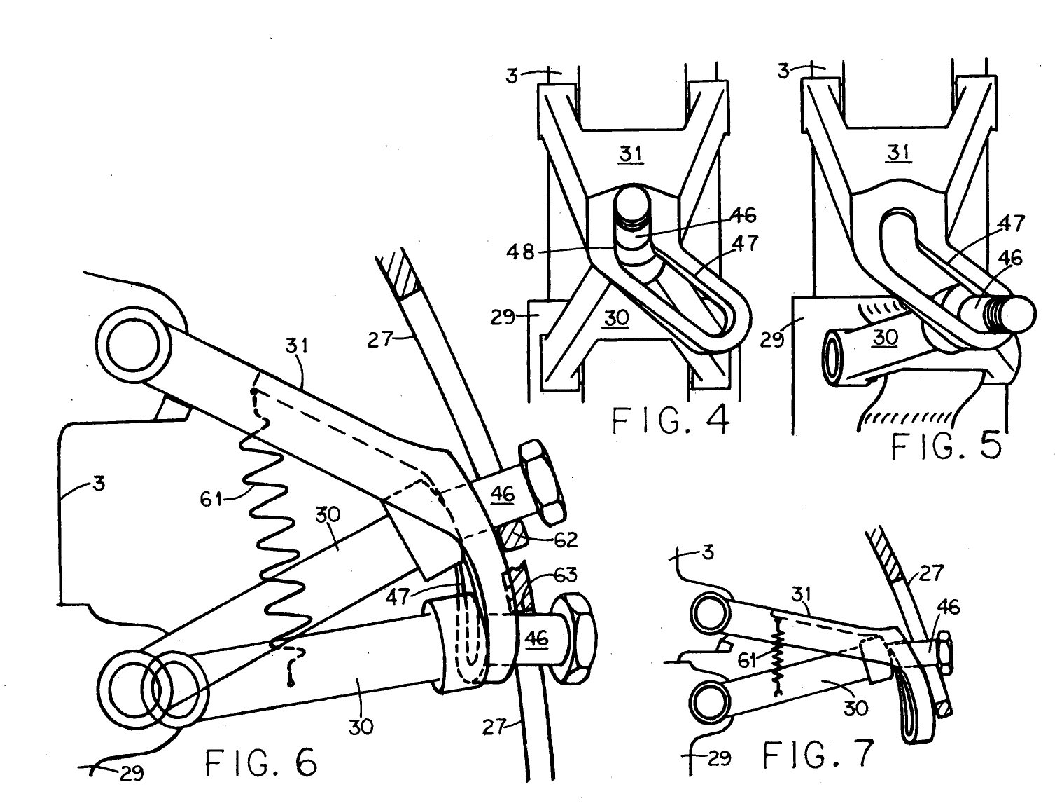

FIG. 4 is an elevation of the bogie orientation scissors in the position for landing the aircraft.

FIG. 5 is an elevation of the bogie orientation scissors in the position of landing gear retracted.

FIG. 6 is a side elevation of the composite parts in FIGS. 4 and 5 plus a slide rod.

FIG. 7 is a side elevation of the parts in FIG. 4 fully compressed during a landing.

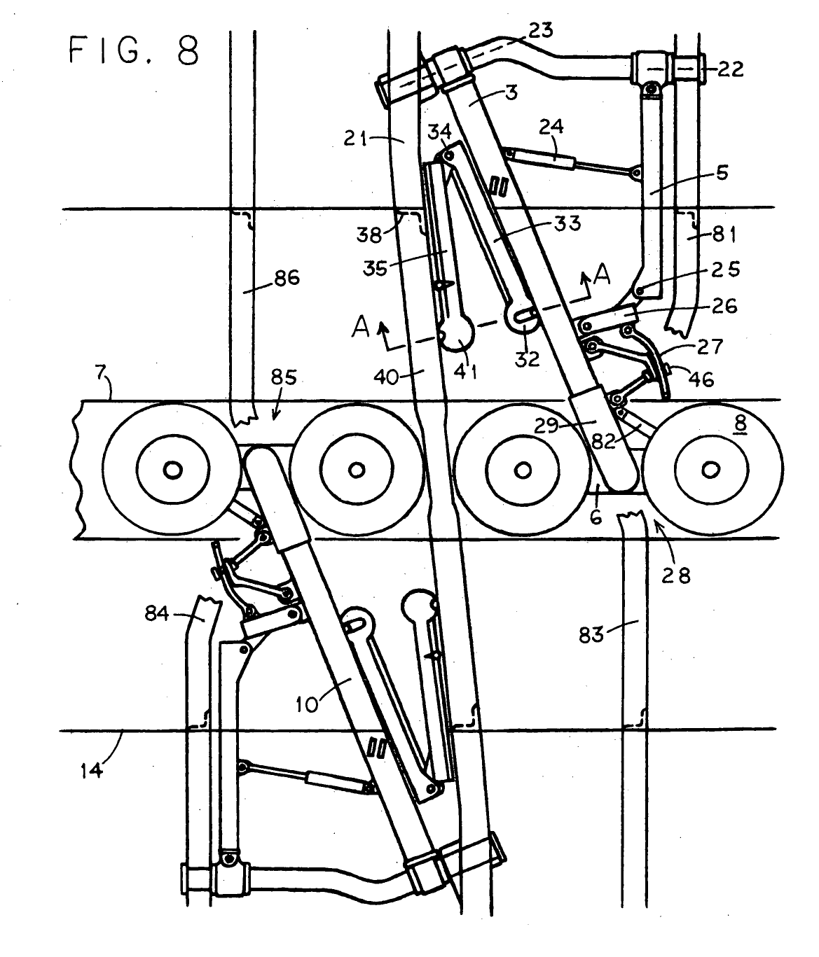

FIG. 8 is a plan phantom view from above of the retracted main landing gear.

FIG. 9 is a cross-section of the side brace ball joints and an elevation of the side brace links.

### DETAILED DESCRIPTION

A limitation on the speed of an aircraft is the cross-sectional area which the aircraft presents to the airstream. The larger this area, the greater the profile drag at subsonic speed, or the greater the wave drag when supersonic. One of the things which increases cross-sectional area is the wing spar where it crosses the fuselage. The spar is a deep structure, for stiffness. In airliners the spar can't very well cross the passenger cabin, so it passes under it instead. This creates a large hold volume handy for storing the landing gear. We eliminate the large hold by dividing the wing spar and routing the thinner halves over and under the passenger cabin. The fuselage becomes slimmer. But this is already known in the art. We build on it for our purposes. Therefore, the text begins with a different set of details about the fuselage. Then a landing gear which is essential to the invention will be shown.

FIG. 2 shows a supersonic airliner design which benefits from the invention. The airliner design is inspired by the Mach 2 Concorde, which was in airline service for two decades. Our general layout is similar to Concorde's. The first differences are the wide-body fuselage 14 which will house more passengers, and the narrowed waist of fuselage 14 to reduce wave drag. But the second item is already known in aerodynamics as area ruling, and will not be further discussed. The invention features a narrow keel 7 below fuselage 14. Keel 7 comprises an empty volume in which the wheels of the main landing gear will be stowed. It is desired that the sum of keel 7's cross-sectional area plus that of passenger cabin 14, is comparable to Concorde's oval fuselage. The ultimate goal is to approach Concorde's performance.

FIG. 1 is a cross section of the fuselage 14 showing passenger cabin volume 16 and keel 7. Cabin 16 contains passenger seat 2 plus six others in the row reaching across to a total of seven (compared to Concorde's four.) Keel 7 encloses main landing wheels 8 and 9. There are more wheels behind them, shown in a later figure. Wheels 8, 9 et al are held by beam 6 which is ultimately connected to main landing gear strut 3. The hole at the right end of strut 3 can turn on a pivot, shown later, which is attached to wing 4 structure. Strut 3 was retracted by hydraulic cylinder 18. The whole aircraft has nearly bilateral symmetry. On the other side of the aircraft, strut 10 is also shown in the retracted position. The two bends in strut 10 enable it to squeeze through the limited space below passenger cabin volume 16. Strut 3 is the mirror image of strut 10 and also has a reverse bend. Strut 3 may fit between the floor joists, if any, in cabin floor 1, and will position the bulky wheels 8, 9 substantially below cabin floor 1.

When extended by hydraulic cylinder 13 for landing, strut 10 would be in a position indicated as 11. An engine nacelle (omitted) would normally be just outboard of position 11. Hydraulic cylinder 13 is housed in partial bulkhead 15 which extends into the cabin volume 16 without, however, intruding into aisle 16's walking space. Bulk-head 15 also braces fuselage corner 14 against flexing when the shock load of landing is carried in part to the roof portion of the fuselage. Attention now turns to the main landing gear.

In FIG. 3, sheet metal is removed around wing spar 21 for visibility. The conventional parts of the landing gear are listed:

Strut 3 pivotably mounted on wing spar 21; drag brace 5, 26;
side brace 33-35; lower strut 29, which can slide upward relative to strut 3 to absorb the mechanical work of landing impact; A-frames 30 and 31 as the alignment scissors for lower strut 29 to strut 3; beam 6 pivoted on lower strut 29 and carrying wheels 8, 9 et al, thus constituting a main wheel bogie 28.

Lower strut 29 could be of smaller diameter than strut 3, and slide inside it. That is the usual arrangement. But here it is drawn as sleeve 29 wider than strut 3 and sliding over it. The reason will be given later.

Door 42 in keel 7 will swing downward during retraction, revealing the keel 7 volume to stow bogie 28. Door 42 pivots on hinges 43 when pushed by actuator 44.

In FIG. 3, the main landing gear is extended for landing. Accordingly, bogie 28 is tracking in the same direction as edge 7 of the keel, which is equivalent to the heading of the aircraft. Of course, the aircraft and bogie 28 are at a high angle of attack, for landing, but the track of the wheels is approximately aligned with the landing strip. Axis 22 of the pivot for drag brace 5 also points straight ahead, so that drag brace 5 can absorb fore-and-aft loads. Side brace 33-35 conventionally absorbs side loads. Thus, landing is completely ordinary. It is largely ignored hereafter. Landing gear retraction after takeoff is the big item.

The bogies of conventional landing gears may swivel, for crosswind landings, and they can level themselves, to land flat on the runway. Our gear has the same two freedoms. Thus, it's tricky to insert bogie 28 cleanly into very narrow keel 7 at the end of landing gear retraction. Bogie 28 has to be oriented carefully. It's the most important single operation for the invention.

FIG. 3 shows the landing gear right after takeoff. The side brace has two links 33 and 35 and a hinge 34. There are ball-and-socket joints 32 and 41. Retraction starts with a pull from hydraulic cylinder 37's piston rod upon link 35. Side brace 33-35 will break at hinge 34, unlocking strut 3 from the vertically extended position. Simultaneously, rod 36 (the piston rod of hydraulic cylinder 18 in FIG. 1) will pull diagonally on strut 3 in FIG. 3. Strut 3 would start to move upward and inward. That would be the beginning of main landing gear retraction. Mostly conventional so far.

However, axis 23 of strut 3's pivot points not straight ahead, but in an outward direction. This is so that strut 3 will angle forward when it retracts upward. Bogie 28 will then enter the front part of keel 7. This is visible in FIG. 8. Simultaneously, strut 10 on the other side of the aircraft would angle backward during retraction. Then its bogie 85 (seen in FIG. 8) would lie in tandem with bogie 28 within keel 7. This is the first goal of the invention. The details of achieving it follow.

Returning to FIG. 3, it's expected that drag brace 5, 26 will shorten during retraction because axis 22 is on the inside of axis 23. Pushed by hydraulic cylinder 24's piston rod, drag brace 5, 26 will break' at joint 25. The end result is seen in FIG. 8. Drag brace 5, 26 is fully broken. Lower strut 26 has turned downward, pushing on slide rod 27. The use of that will be shown later.

In FIG. 3, the difference from usual landing gear retraction will appear as strut 3 turns about axis 23 in order to move upward and forward. Bogie 28 must then start to swivel to its left. That is because wheels 8 and 9 were “toed-in” relative to axis 23 when the gear is down as shown. The toe-in means that wheel 8 would be too high when bogie 28 reached keel 7. Wheel 8 would hit the keel ceiling 45 before the other wheels were fully housed in keel 7. Therefore, bogie 28 must swivel left during retraction.

It is noted that U.S. Pat. No. 5,000,400 neatly sidesteps the problem by making the strut pivot (his trunnion 92) point partly toward the ground. That is seen in his FIGS. 2, 13, and 15. It counteracts his wheel truck's toe-in. However, his partly downward trunnion 92 would load his wing spar sideways during landing. We chose a different solution. As a result, our strut 3's pivot axis is level with the wing.

FIG. 4 shows the scissors made by A-frames 30 and 31 pointing straight ahead as in FIG. 3. This is the position for landing the aircraft. It remains the same right through the next takeoff. The alignment is established by stud 46 being located in the top part 48 of angle groove 47. Stud 46 is part of A-frame 30, and angle groove 47 is part of A-frame 31. That sets the alignment of sleeve 29 to strut 3 for landing. How stud 46 got to where it is will be shown in FIG. 6.

FIG. 5 illustrates the position of the components when the landing gear will be fully retracted. Now stud 46 is at the bottom of the angled part of angle groove 47. A-frame 30 has been forced to turn. It turned sleeve 29 with it. Sleeve 29 in FIG. 3 carries bogie 28, so that is how bogie 28 is swiveled for retraction.

FIG. 6 shows that the motions of stud 46 are obtained by the action of slide rod 27. FIG. 6 is a side view of the components and is a composite drawing which recaps both FIGS. 4 and 5. Thus, there are two images of A-frame 30. The top image of A-frame 30 corresponds to FIG. 4: Stud 46 is in the high position within angle groove 47. The bottom image of A-frame 30 corresponds to FIG. 5, with stud 46 in the low position within angle groove 47. Stud 46 was pulled up by the bottom loop 62 of slide rod 27, or else pushed down by the heel 63 of the slot in slide rod 27. Thus, the whole operation is controlled by the motions of slide rod 27. They correspond to the two positions of bogie 28. The position for landing and takeoff was seen in FIG. 3. The position when the landing gear is retracted is seen in FIG. 8.

FIG. 8 illustrates the desired end of landing gear retraction. Viewed from above the aircraft, passenger cabin 16 and its contents are omitted, including floor 1 from FIG. 1. The outlines of fuselage 14 and keel 7 remain. Wing skin is omitted for visibility. The direction of flight is to the right. Strut 3 has fully retracted by pivoting about axis 23, which is fixed to wing spar 21. Strut 3 is now substantially flat in the wing, and the aircraft is in flight.

Reviewing previous material, the offset of drag brace hinge 22 to strut 3's pivot axis 23 has caused drag brace 5, 26 to shorten during strut 3's retraction. Drag brace 5, 26 broke at hinge 25, and the brace's lower half 26 turned on its pivot at strut 3. Slide rod 27 was pushed toward stud 46, causing the action resulting in FIG. 5. That is how bogie 28 was “steered” for retraaction. Viewed in a different way, in FIG. 8 bogie 28 is co-planar with axis 23. Additionally, beam 6 now had to dip to a new angle for bogie 28 to enter keel 7 cleanly. Its former alignment, the perpendicularity of beam 6 to sleeve 29 in FIG. 3, had to be altered to “droop” wheels 8 and 9. In FIG. 8, that was accomplished by a push from hydraulic cylinder 82. It's just an adaptation of a bogie beam damper.

The end result of all these operations is to place bogie 28 inside keel 7 cleanly. Bogie 28 is now substantially aligned with keel 7 in horizontal and vertical planes. The other landing gear strut 10 went through similar operations and ended up fully retracted in FIG. 8. It caused bogie 85 to enter keel 7 aligned with it too. This accomplishes one goal of the invention: Bogies 28 and 85 stored in tandem allow keel 7 to be much narrower than fuselage 14.

However, the topic of landing gear retraction is not exhausted. Next is the issue of side brace 33-35 folding as strut 3 retracts. It's a little involved. Side brace links 33 and 35 formed a “V” as strut 3 angled forward while it moved upward. Pivots 32 and 41 are ball joints to allow this motion. But joint 34 is a simple hinge, so it had to twist a lot from its orientation in FIG. 3 to let links 33 and 35 form the “V” seen in FIG. 8. These items are seen in more detail in FIG. 9.

FIG. 9 shows ball joints 32 and 41 in cross section and links 33 and 35 in elevation. Ball joint 32 is connected to strut 3, and ball joint 41 is connected to spar segment 40. The long links 33 and 35 appear foreshortened because they are seen in the length of the “V” in FIG. 8. In FIG. 9, hinge 34 has almost closed. Axis 91 of hinge 34 makes an angle of 70 degrees to former axis 92 from FIG. 3. Thus, the folding of side brace 33-35 during retraction is a three-dimensional affair. Links 33 and 35 had to twist considerably to reach the position seen in FIGS. 8 and 9. The twist was started when hydraulic cylinder 37 of FIG. 3 pulled on ball joint 39, which is off-center on link 35. In FIG. 9, the ball of ball joint 39 is seen to be considerably off-axis to the centerline of link 35. (The centerline is not shown, but would run down the middle and the length of link 35.) Of course, the fully twisted link 35 has turned ball joint 39 seventy degrees beyond its orientation in FIG. 3. The pull on ball joint 39 would have ceased long before ball 39 reached the point seen in FIG. 9. Otherwise, continued pull would have stopped the twist. A brief pull from actuator 37 in FIG. 3 will start the twisting while it breaks the brace. Once started in FIG. 3, the rest of the twist and the break should follow naturally as links 33 and 35 continue to fold toward the end seen in FIG. 8.

The twisting folding of side brace 33-35 is largely anticipated by the twisting folding of brace 23, 24, 31 of U.S. Pat. No. 3,086,733. The progression of the folding is seen in his FIGS. 2-4. His FIG. 2 corresponds to our FIG. 3 (gear down) and his FIG. 4 corresponds to our FIG. 8 (gear retracted.) His FIG. 3 shows an intermediate position during twisting folding. The most significant difference is that his hydraulic cylinder 38, which breaks the brace, pulls at the center of his hinge 31 (His FIG. 5.) Apparently the twisting will start automatically. Our method is a more positive beginning to the action. A lesser difference is his double articulate joints 26-27 and 32-33 instead of our ball joints 32 and 41. His may be //easier to manufacture. They are considered equivalent in the Claims.

In FIG. 9 the large open arc in ball socket 32 is only the clearance groove for ball post 93. Ball socket 32 can enclose the ball much more than the cross section suggests. The same thing with ball socket 41. Ball socket 32 with its clearance groove is seen more completely in FIG. 8. The clearance groove is partly seen in FIG. 3. Its orientation should let link 33 start to twist when the brace breaks. Of course, the shape of the clearance grooves must allow the twisting to synchronize with the folding. This concludes the discussion of landing gear retraction. Re-capping, only the half of the main landing gear on the left side of the aircraft, namely strut 3, its braces and its bogie, was examined in detail. The operations on strut 10 and its equipment were assumed to be similar.

In FIG. 7, the scissors made by A-frames 30 and 31 close up during landing. Sleeve 29 rides upward over the end of strut 3, absorbing the landing impact through conventional oleo action. The shock of landing, however, might cause A-frames 30 and 31 to bounce in and out of the engagement seen in FIG. 4. In other words, stud 46 could slip out of the top part of angle groove 47. Then the bogie would swerve, a problem. In FIG. 7, spring 61 tension should prevent that by pulling A-frames 30 and 31 together. Stud 46 will stay in the vertical part 48 of angle groove 47 in FIG. 4.

At the same time, stud 46 is at the midpoint of slide rod 27 in FIG. 7. Slide rod 27 has no effect there. Landing should proceed without incident. This concludes the discussion of landing gear operation. The text reverts to the fuselage modifications.

FIG. 1 shows the airframe's adaptation to the landing gear. Strut 3 and strut 10 have a certain thickness for which room is found at the bottom of the fuselage. The same goes for cabin floor 1 under passenger cabin volume 16. In addition to that, upward loads from wing 4 during flight and when landing must be transmitted in part along the bottom of fuselage 14. (Keel 7 is omitted completely from this discussion.) Thus, three types of structural members will compete for the space below passenger cabin volume 16. First in consideration is the loads from wing 4.

In FIG. 3, wing spar 21 divides into two thinner portions 38 and 40 where it meets the fuselage. Numerals 21, 38 and 40 point to the suggested cross sections. Spar portion 40 continues horizontally to the left. As seen in FIG. 8, spar portion 40 crosses the width of fuselage 14. It thereby transmits some of the wing loads. Secondary spar 81, 83 supports the pivot 22 for drag brace 5, 26 and also crosses fuselage 14. Similarly with secondary spar 84, 86. These, then, are the main load-carrying members at the bottom of fuselage 14. Between them is enough space to store landing gear struts 3 and 10 in FIG. 8. There's enough room for drag brace 5, 26 and side brace 33, 35 beside strut 3 too. Similarly with strut 10 and its braces. Thus, two out of the three types of load-bearing members are accommodated.

Strut 3 or 10 is about the same thickness as spar 40. If a strut can fit under the passenger cabin, so can spars 40; 81, 83; and 84, 86. In FIG. 1, struts 3 and 10 do fit under passenger cabin 16, so there was no need to draw the spars. It's understood that they fit too. That leaves cabin floor 1. It is drawn symbolically as an un-differentiated thickness. Floors are usually joists spaced apart and supporting a thin slab to walk on. Our spars could double as joists, and the slab (not shown specifically) could be honeycomb sandwich panels resting on the spars. Thus, it appears that spars, struts, and cabin floor members can all fit under passenger cabin 16.

The wide, flat roof of fuselage 14 will bulge from cabin pressurization, and buckle under aerodynamic loads. A solution from the past is applied. Stays 17 like from old fire-tube boilers strengthen the long walls by tying them together. Stays 17 should fit between the seat backs of passenger seats to avoid cramping the passenger cabin volume.

Further bracing of the cabin structure is supplied by floor-to-ceiling partial bulkheads 15 and 20. Too, vertical dividers 19 of the overhead luggage racks can stiffen the upper corners of fuselage 14. Also, thin fillet 12 below the passenger's knees braces a lower corner without cramping the legs too much. These additions strengthen the structural loop around cabin volume 16 which starts with spar branch 38 of FIG. 3. In FIG. 1, partial bulkhead 20 turns the right side of fuselage 14 into a more rigid whole. Then the bending load from wing 4 is transmitted to the cabin roof where bulkhead 20 ends. In other words, along an angle similar to that made by the slanting of hydraulic cylinder 18. This is a more efficient way to transmit the loads than to route them all the way around the perimeter of the rectangular envelope of fuselage 14.

Still, nothing herein prevents a drastic rounding of the fuselage upper corners such as 14, in order to decrease fuselage cross-sectional area and therefore drag some more, at the cost of some headroom.

Continuing the process, partial bulkheads 15, 20 could be duplicated at other cabin stations crossed by spars such as 81, 83 and 84, 86 of FIG. 8. Spar 81 is seen interrupted at slide rod 27. Spar 81 would have to become shallow to squeeze over sleeve 29 and join spar segment 83. The same thing would happen to spar segment 84 passing over bogie 85 to join spar segment 86.

Two short topics follow. 1) In FIG. 8, bogies 28 and 85 stored in tandem by no means fill the whole length of keel 7, which stretches fore and aft for streamlining. The extra volume can store passenger luggage. 2) In FIG. 2 the wide flat roof of fuselage 14 extends backward to the tail, where a control surface 50 is a natural addition. Control surface 50 trims the aircraft at low speeds, but reverts to streamline when the center of lift moves aft during supersonic cruise. It avoids having to pump fuel to a balancing tank to level the aircraft.

Returning to the landing gear, lower strut 29 in FIG. 3 is in the form of a sleeve 29 which is wider than strut 3. This is contrary to usual practice. For instance, in FIG. 2 of U.S. Pat. No. 4,720,063, lower strut 24 is thinner than upper strut 22. In FIG. 2 of U.S. Pat. No. 4,984,755 lower strut 5 is thinner than upper strut 1. Our reason for inverting the normal arrangement is found in our FIG. 1. Strut 10 is relatively thin so it can pass under passenger cabin 16 and still leave a little thickness from cabin floor 1 above strut 10 for the passengers to walk on. That was part of how the cross-sectional area of fuselage 14 was kept to a minimum, for lower drag losses. But certain consequences follow. Returning to FIG. 2 of U.S. Pat. No. 4,720, 063, it is seen that lower strut 24 is nearly as thick as upper strut 22. In FIG. 2 of U.S. Pat. No. 4,984,755, lower strut 5 is nearly as thick as upper strut 1. The implication is that the lower struts must be relatively thick for enough strength to support the bogie or wheel. Since our struts 3 or 10 are already thin, it's difficult for an even thinner strut sliding inside strut 3 or 10 to avoid bending under the landing shock. Sleeve 29 solves the strength problem by being wider than strut 3. Also, since sleeve 29 can be the stronger of the two, it might be made of titanium, which is only 57% as heavy as steel, a significant weight saving. Still, some other, thinner lower strut, in the form of a solid rod, is not excluded from the Claims, because of continuing advances in metallurgy.

A fringe benefit would be that, in FIG. 8, minor spars 81, 83 wouldn't need to flatten so much to squeeze over lower strut 29 if it was thinner than strut 3.

An overview. It is apparent from the cross section seen in FIG. 1 that the aircraft is close-cowled. That is, not only is the landing gear squeezed into a minimum volume (keel 7), but so is passenger cabin space 16. The low ceiling, partial bulkhead 15, stay 17 and fillet 12 are all intrusions into the passenger area which decrease passenger comfort. On the other hand, flight time at Mach 2 on overseas routes would be half of the time in a subsonic airliner. The two realities could largely offset each other. The passenger seating in FIG. 1 is the maximum row size. The pinched waist of fuselage 14 for area ruling seen in FIG. 2 means that there would be fewer than seven seats across. Say 5 seats; but there is room for more seats in the tail, which is no longer too narrow. Similarly up front, because the crew didn't get more numerous. The seating ratio to Concorde's can be kept at 7:4. Then passenger seat miles rise by 75%, and per-capita operating costs drop by 3/7=43 per cent.

A side benefit of 5-across seating is that the now-isolated window seats can be bigger, for large passengers.

We end with a long segment to see how close the invention comes to reaching its stated goals. It starts with measuring the cross section of our wide-body fuselage, then comparing to Concorde's fuselage's cross section. The widths of the fuselages scale as 7:4, the ratio of seats across in the cabin. This sets the dimensions of the drawings for comparison. A cross section of Concorde's fuselage is FIG. 22 of Paper 912162, Society of Automotive Engineers (“SAE”). Comparing our FIG. 1 to that FIG. 22, it is found that our FIG. 1 has 50.5% more cross-sectional area. A sizeable enlargement. A downward adjustment is the elimination of Concorde's high-drag landing gear fairing, shich costs 10% of payload (Section 6.4, SAE Paper 912162.) Our keel 7 is the most streamlined component of the aircraft. Subtracting Concorde's landing gear fairing's area from our nominator lessens the cross-sectional area increase represented by our FIGS. 1 to 39.5%.

The fuselage creates only part of the profile drag. Wings, tail, and nacelles also contribute. Measuring those drags uses the frontal view of Concorde in the lower Figure on page 83, JANE's All The World's Aircraft, 1978-79. It is found that its fuselage constitutes some 27.2% of the total cross-sectional area. Our wider fuselage then represents a (0.272)(39.5%)=10.7% increase in form drag.

A further penalty is that our wide-body fuselage adds some surface to the wetted area of the aircraft. Another comparison reveals a 19% increase by our passenger cabin plus keel over Concorde's fuselage plus landing gear fairing. Adding the tail, nacelles, and the wings to the denominator of a comparison ratio, our 19% increase corresponds to only 2.8% more total surface, therefore friction drag.

Subsonic form drag computed above becomes wave drag past Mach 1. This makes up 37.5% of total drag at cruise. (FIG. 2 of SAE Paper 751056, also in 1975 SAE Transactions, page 2944.) Friction drag adds a 32.5% share. Thus, only a fraction of the losses found so far would apply: ((37.5)(10.7)+(32.5)(2.8))/100=4.94% greater total drag. It is seen that the graph, FIG. 2 of SAE Paper 751056 is the main basis for the analysis.

Additionally, there will be two weight increases. These will necessitate more wing lift, which creates more drag. The first weight increment is caused by 75 more passengers.' At an average weight of 160 lbs each, that is (75)(160)=12,000 lbs. The second weight increment is caused by the wide fuselage. It is roughly proportional to the increase in the aircraft cross-sectional area computed above of 10.7%. Concorde empty weight is 173,500 lbs (JANE'S, page 84). Structure weight can be approximated by subtracting the weight of things which don't change: Four engines at 7465 lbs each (JANE's, page 695), totaling 29,860 lbs; two nacelles, whose volume proportion of total bulk is 10.4 percent, giving some 10,400 lbs estimated; landing gear 17,350 lbs (ten percent of empty weight, an estimate); air conditioning, fuel tanks or liners, windows, avionics, instrument panel, wiring, fittings, nose droop mechanism: 15,000 lbs estimate. Structure weight of Concorde is then approximately 173,500−29,860−10,400−17,350−15,000=100,890 lbs. Structure weight goes up by (10.7%)(100,890)=10,790 lbs. Total weight increment is 12,000+10,790=22,790 lbs.

Concorde maximum takeoff weight is 400,000 lbs (JANE's, page 84). The per cent increase in gross weight is 22,790/400,000 32 5.7%. That translates to greater wing lift required, which means more drag. Using again FIG. 2 from SAE Paper 751056, the remainder is drag due to lift, plus wave drag due to lift, which add up to 30% of total drag at Mach 2.0. The net drag increase from the wing is (30%)(5.7%)=1.71%.

Grand total drag increase is then 4.94%+1.71%=6.65%. Using strict proportionality, the new cruise speed is Mach 2−(2)(0.0665)=1.867. That's how close we can come to existing Concorde performance without other changes. We note that a representative of the engine manufacturer implied that a Mach 1.8 cruise is acceptable (Aviation Week & Space Technology, Jan. 1, 2000, page 56.)

At Mach=1.867 cruise speed, Concorde's range of 4,000 miles would drop by 6.65% to our 3,734 miles. Range can be increased by adopting the “B” wing design (briefly described in SAE Paper 800732 also in SAE Transactions, 1980, page 2276.) The lift/drag ratio is 7.8, compared to Concorde's 7.3 (SAE Paper 892237, page 3.) It is an improvement of 6.8%. When it is applied at the 30% wing drag fraction of total drag, or 2.04%, speed and range go back up by that amount to 3,820 miles and Mach=1.907. It's not much trouble to incorporate the “B” wing: Our wing structure, for instance the spars in FIG. 8, is different anyway. Gas mileage is (3,820)/4,000=95.5% of what it was. Thus, with the help of the “B” wing, a wide body Mach 2 airliner design is nearly achieved. The real payoff remains, 75 more passengers, which reduces the per-capita operating cost by (43%)(0.955)=41 percent.

Standard construction in aluminum was assumed, but the growing use of lighter and stronger modern composites would reduce weight and allow a thinner wing, for higher cruise speed and more range. Advances in engine design were not considered, although they would be required at least to meet FAR Part 36 noise limits. Still, a proposal known as the Mark 622 was some simple changes to the Olympus 593 engines from the manufacturer and reported in previouslycited SAE Paper 800732, also in 1980 SAE Transactions. On pages 2276, 2278, and 2280-83, small enlargement of the first three stages of the low pressure compressor gave airflow growth of 15 or 20% (changes 2 and 7 on page 2282.) The 20% increase, after some small compression, was routed directly to the jet pipe as bypass flow, giving a 4% drop in fuel use. The 15% increase had the advantage of requiring only a small increase in low-pressure turbine diameter (using paragraph 5, page 2282.) It was also notionally retrofittable in the existing aircraft. 15% extra flow going to bypass would give a 3% drop in fuel use. Range would be back up to 3,820+(0.03)(4,000)=3,940 miles. Thus, practically unchanged for an airline. That, and cruise speed of Mach 1.9, are the closest approach to Concorde performance without completely new engines. Savings in per capita operating costs are back up to (43%)(0.985)=42.3 percent.

Housekeeping items follow:
a) The outline of fuselage 14 in FIG. 8 ignores the pinched waist for area ruling of FIG. 2. This is so that a proper comparison of the widths of narrow keel 7 versus the typical width of fuselage 14 can be made in FIG. 8. In a real aircraft, the greatest indentation of the pinch would be near the axial station of sleeve 29.
b) In FIG. 1, drag brace 5 is drawn as straight, but that's only to avoid obscuring the right-most end of strut 3. Brace link 5 could have a shallow upward bend in it too.
c) The proposed “B” wing 4 in FIG. 2 was planned to have moveable leading-edge slats, for better low-speed lift. These weren't shown in FIG. 2 because they are well known in the art.
d) A Concorde-type bogie comprising four wheels in two pairs was pictured throughout. Other bogie styles can work: Three wheels in a single column like in FIGS. 13-14 of U.S. Pat. No. 5,000,400. Then our keel 7 would be even smaller, for less drag.

The scope of the invention can be found in the appended Claims.

1. In an aircraft including fuselage means and two wings; said fuselage means including a cabin and a keel; said keel narrower than said cabin; said keel having door means opening to an empty volume; said empty volume able to house the wheel bogies of the main landing gear when retracted; said main landing gear including two struts each having connection means at one end to a said wheel bogie; each said strut associated at its other end by pivot means to a wing spar, and able to retract upward and inward toward said keel; each said wheel bogie including a beam and several wheels; said wheels rotatably mounted on said beam; one said strut able to said retract with an additional forward component; the other said strut able to said retract with an additional backward component; so that the two said wheel bogies lodge in tandem fashion, one behind the other, within said keel; such that said keel's cross-sectional area means can be substantially only big enough to house one said bogie, in order to decrease aerodynamic drag.

2. The aircraft of claim 1 in which each said strut is paired with a lower strut; each said lower strut carrying a said beam and being said connection means between a said strut and a said wheel bogie; each said strut and lower strut together adapted to compress for absorbing landing shock; each said lower strut able to perform a swivel relative to its said strut and capable of stopping at two different positions along said swivel; first said position making said bogie track substantially in the same direction as said aircraft, for landing or for takeoff; and second said position making said bogie when retracted substantially flat against the ceiling means of said keel, so that one said wheel doesn't hit said ceiling means too soon when,retracting.

3. The aircraft of claim 2 in which said lower strut is a sleeve of greater diameter than said strut; said sleeve sliding over said strut to said compress for said absorbing landing shock.

4. The aircraft of claim 2 in which scissors means define said two positions of said lower strut; said scissors means comprising first A-frame pivoted on said strut, and second A-frame pivoted on said lower strut; said first A-frame having a slot; said second A-frame having a stud; said slot having a vertical part and a slanted part; said stud located within said slot; said stud being in said vertical part when said lower strut is in said first position; said stud being in said slanted part when said lower strut is in said second position; two-link drag brace with a hinge joining said links; said drag brace pivotably mounted at its lower end to a said strut and at its upper end to a said wing's structure; said drag brace's mount at said wing's structure not being aligned with said pivot means for said strut, thereby requiring a folding of said drag brace at said hinge to shorten said brace upon said landing gear retraction; said folding causing the lower said link to pivot at said strut; the other end of said lower link approaching said A-frame with said stud; slide rod means pivoted at one end to said lower link near said hinge; said slide rod means abutting at its other end to said stud; and said slide rod means pushing said stud into said slanted part, thereby turning said second A-frame and putting said lower strut into said second position.

5. The aircraft of claim 1 in which said cabin is a passenger cabin with seats, said passenger cabin at least twice as wide as it is high; and vertical stays connecting the floor means of said cabin to its roof means, in order to strengthen the assembly; each said stay located substantially between the seat backs of two said seats, for a compact fit.

6. The aircraft of claim 1 in which a said strut has a middle se- gment; said middle segment fitting under said cabin; said wing spar dividing into two portions where it meets said fuselage means; one said portion turning upward to constitute part of one side wall of said fuselage means, then turning toward the horizontal to constitute part of the roof means of said cabin; the other said portion proceeding substantially horizontally to form part of the floor means of said cabin; said other portion being about as deep as said middle segment is thick, so that both parts occupy shallow spaces under said cabin; said shallow spaces being found between floor joist means of said cabin, in order to limit the cross-sectional area of said fuselage means.

7. The aircraft of claim 6 and a side brace for said strut; said side brace when extended able to lock said strut in the down position for landing; said side brace including two links joined at a hinge and whose other ends are ball joint means; one said ball joint means pivoted on said strut; the other said ball joint means pivoted on said other portion; said side brace capable of folding on said hinge; said folding being the start of retraction of said strut; said folding initiated by a pull from an actuator upon a third ball joint means attached to one said link; said links during said folding also twisting so that they form a “V” whose plane is at a large angle to their former plane when said side brace was extended; and said twisting being initiated by said pull on said third ball joint means mounted on the side of said one link.

8. The aircraft of claim 6 in which said one portion and said other portion of said wing spar are tied together by partial bulkhead means extending from said floor means to roof means of said cabin; said partial bulkhead means making said fuselage means more rigid at two corner means substantially vertically aligned with each other; said partial bulkhead means advancing horizontally enough into said cabin to house actuator means whose pull rod reaches said strut lowered for landing; said actuator means able to said retract said strut when said aircraft is in flight.

9. The aircraft of claim 4 in which said A-frames are connected by spring tension always tending to pull said A-frames together such that said lower strut is in said first position; but said pushing by said slide rod means on said stud overcoming said spring tension.

10. The aircraft of claim 1 in which a said strut has a shallow reverse bend consisting of two bends in opposite directions and with a length between them; said length of said strut when retracted lying below said cabin and substantially parallel with it; one said bend directing an end of said strut shallowly upward toward said pivot means; the second said bend directing the other end of said strut shallowly downward toward said keel, in order to place a said wheel bogie substantially below the floor means of said cabin.
